(19) United States
(12) Patent Application Publication
(10) Pub. No.: US 2009/0172004 A1
(43) Pub. Date: Jul. 2, 2009

(54) METHOD AND SYSTEM FOR GENERATING A DATA OBJECT ASSEMBLY

(76) Inventor: HERBERT HACKMANN, Wiesloch (DE)

Correspondence Address: SAP AG, 3410 HILLVIEW AVENUE, PALO ALTO, CA, 94304, US

(21) Appl. No.: 11/965,793

(22) Filed: Dec. 28, 2007

(51) Int. Cl. G06F 17/00

(52) U.S. Cl. 707/102

(57) ABSTRACT

A method and system for generating a data object assembly is provided. A modeling pattern having a node arranged in a hierarchy of nodes is provided. An element provider is registered for use in the modeling pattern. An element type is configured for the element provider. The element provider is assigned as a parent node to the node. The element type is assigned as a child node to the element provider. A data object assembly is generated using the modeling pattern.

### TECHNICAL FIELD

Embodiments of the invention generally relate to computer systems, and more particularly to a method and system for generating a data object assembly.

### BACKGROUND

In the business software world, most of the business software is typically developed in a model driven way. The process of developing software in a model driven way generally involves identifying fine-granular and standardized data models and mapping a set of data objects to the data model to generate a data object assembly. The data object assemblies typically define a well defined business processes. The data object assembly is typically generated at modeling time or design time and a user is not allowed to make any changes to the data object assembly. Currently there is no software development method available that provides a flexible programming model to allow the user to develop a required data object assembly both during configuration time or runtime. These software development methods do not provide any ready to use components that may be configured during configuration time or runtime to generate the data object assembly of choice for use in an application.

### SUMMARY OF THE INVENTION

Embodiments of the invention are generally directed to a method and system for generating a data object assembly. A modeling pattern having a node arranged in a hierarchy of nodes is provided. An element provider is registered for use in the modeling pattern. An element type is configured for the element provider. The element provider is assigned as a parent node to the node. The element type is assigned as a child node to the element provider. A data object assembly is generated using the modeling pattern.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a functional block diagram of a system for generating a data object assembly according to an embodiment of the invention.

FIG. 2 is a functional block diagram of a system for implementing a data object assembly at runtime according to an embodiment of the invention.

FIG. 3 is a flow diagram of a process for generating a data object assembly according to an embodiment of the invention.

FIG. 4 is a flow diagram of a process for generating a data object assembly according to an embodiment of the invention.

FIG. 5 is a flow diagram of a process for implementing a data object assembly at runtime according to an embodiment of the invention.

FIG. 6 is a block diagram of a system for generating a data object assembly useful for implementing the invention according to an embodiment of the invention.

### DETAILED DESCRIPTION

Embodiments of the invention are generally directed to a method and system for generating a data object assembly. A modeling pattern having a node arranged in a hierarchy of nodes is provided. An element provider is registered for use in the modeling pattern. An element type is configured for the element provider. The element provider is assigned as a parent node to the node. The element type is assigned as a child node to the element provider. A data object assembly is generated using the modeling pattern.

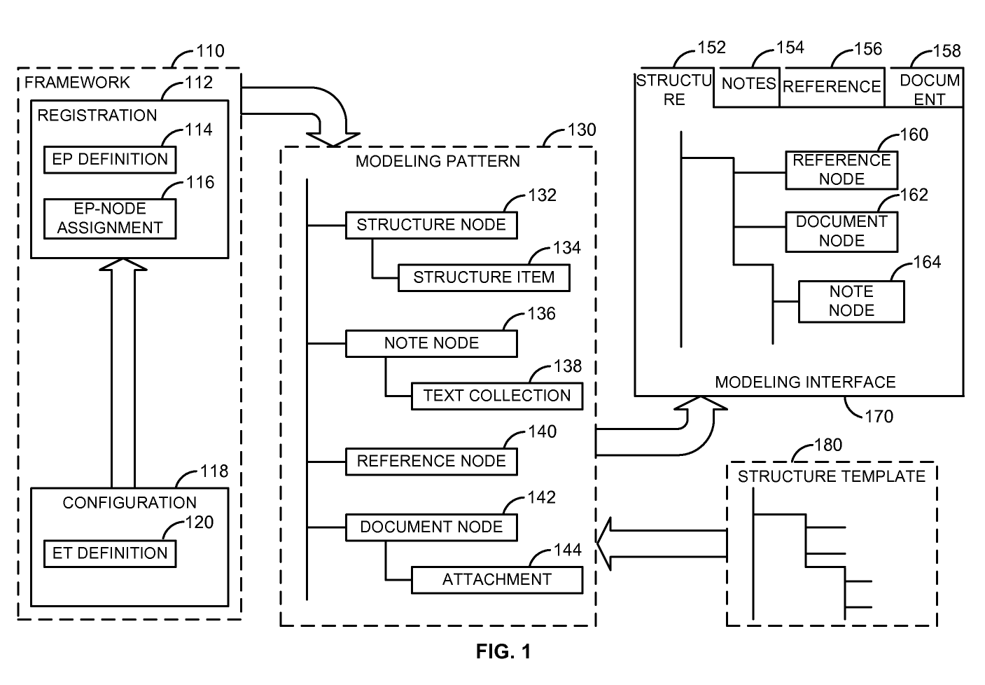

FIG. 1 is a functional block diagram of a system for generating a data object assembly according to an embodiment of the invention. Modeling pattern 130 typically includes a number of nodes arranged in a hierarchical order. A node in modeling pattern 130 usually has one or more element providers (EP) modeled as the node. The element providers are typically technical providers behind the node including services like data object links handling, node handling, document handling and activity request handling. The activity request handling generally includes requests for create, modify, display and the like. Thus, the element provider fixes the backend behavior of the node by fixing a specific data structure, the actions and the queries needed to work with the node. An element provider node may typically have one or more element types associated with the element provider. In an embodiment, the element provider node is a parent node and one or more element types (ET) are associated with the element provider node as child nodes to the element provider node. The element types are typically data objects that a user may work with. Element providers are usually invisible and the user generally works with the element types.

Modeling pattern 130 is typically supported by framework 110. Framework 110 includes registration 112, configuration 118 and a runtime handling (not shown). Framework 110 is the backbone of modeling pattern 130 and enables modeling pattern 130 to handle all data objects in the same way without changing the modeling pattern. It is usually the responsibility of framework 110 to handle the element providers, the element types and the activities performed on the element providers and the element types.

Besides the modeling of an element provider as a node in modeling pattern 130, it is required to register the element provider in framework 110. Registration 112 typically registers the element providers and includes node assignment 116 and element provider definition 114. Node assignment 116 includes assigning an element provider to a node in modeling pattern 130. Node assignment 116 is typically done by assigning node identifiers of the nodes in modeling pattern 130 to the respective element providers. Element provider definition 114 typically includes one or more customizing attributes specific to each of the element types. An example of the customizing attribute is a data object proxy name. In an embodiment registration 112 is stored in a framework registry table.

When an element provider is modeled in modeling pattern 130 and registered in registration 110, at least one element type corresponding to the element provider must be configured in configuration 118 for the user to be able to work with the element provider. Configuration 118 includes element type definition 120 having definitions of one or more element types for each registered element provider. Each element type definition 120 includes a language dependent short text that is typically visible to the user as the name of the element type while working with the modeling pattern in a user interface. Element type definition 120 further defines values for valuating customizing attributes declared by the element provider during registration 112. For example, an element provider “data object reference” may declare a customizing attribute “data object proxy name” during registration 112. An element type “sales order” may define a value “SALES_ORDER” to valuate the customizing attribute declared by the element provider “data object reference”.

Structure node 132, note node 136, reference node 140 and document node 142 are element providers modeled as nodes in modeling pattern 130. Structure node 132 is typically the most important node in modeling pattern 130. Structure node 132 may include one or more structure items 134. In an embodiment, structure item 134 may either be an element provider node or an element type associated with structure 132. Note node 136 is an element provider for text collection 138. In an embodiment text collection 138 may either be an attachment to note node 136 or an element associated with note node 136. An element is typically an instance of a data object. Reference node 140 may be used to link one or more elements to modeling pattern 130. Document node 142 is typically used to incorporate one or more documents in modeling pattern 130. In an embodiment, one or more documents may be stored as an attachment 144 to document node 142. In an embodiment the documents may be linked as elements to document node 142. In an embodiment, structure item 134 may include one or more of note node 136, reference node 140 and document node 142. In an embodiment, modeling pattern 130 may have multiple nodes for each of structure node 132, structure item 134, note node 136, reference node 140 and document node 142. In an embodiment an element of a first element provider may be linked to an element of a second element provider in modeling pattern 130.

Structure template 180 may be defined as part of framework 110 during a configuration time or during a runtime by the user. Structure template 180 typically defines the hierarchical order of the nodes in modeling pattern 130. Structure template 180 is generally defined as part of framework 110 during the configuration time if a hierarchical order or modeling pattern 130 is already known for a business scenario.

In an embodiment, structure node 132 along with one or more structure items 134 are presented as structure 152 in modeling interface 170. Structure 152 may be used by the user to generate a data object assembly to suit a business process. Structure 152 typically includes interface elements reference node 160, document node 162 and note node 164 mapped to the corresponding nodes in modeling pattern 130. In one embodiment, structure 152 has exactly one interface element for each node in modeling pattern 130. Reference node 160 maps to reference node 140 in modeling pattern 130 and may be used by the user to link one or more elements to reference node 140. The element types for reference node 140 are typically configured in framework 110 during the configuration time. The user is generally presented with a list of the element types configured in framework 110 on selecting reference node 160. The user may then select an element type of interest from the list. On selecting the element type the user may link an element to reference node 140. The element may either be generated during runtime or selected from a list of available elements.

Document node 162 is typically mapped to document node 142 in modeling pattern 130. Document node 162 may either be used to attach documents to document node 142 or link one or more document elements to document node 142.

Note node 164 is typically mapped to note node 136 in modeling pattern 130. Note node 164 may either be used to attach text collections 138 to note node 136 or to link one or more text elements to note node 136.

In an embodiment, note node 136, reference node 140 and document node 142 may be presented as tab-strips notes 154, reference 156 and document 158 respectively in modeling interface 170. Tab-strip notes 154 may be used to attach text collections 138 to note node 136 or to link one or more text elements to note node 136. Tab-strip reference 156 may be used to link elements to reference node 140. Tab-strip document 158 may either be used to attach documents to document node 142 or link one or more document elements to document node 142.

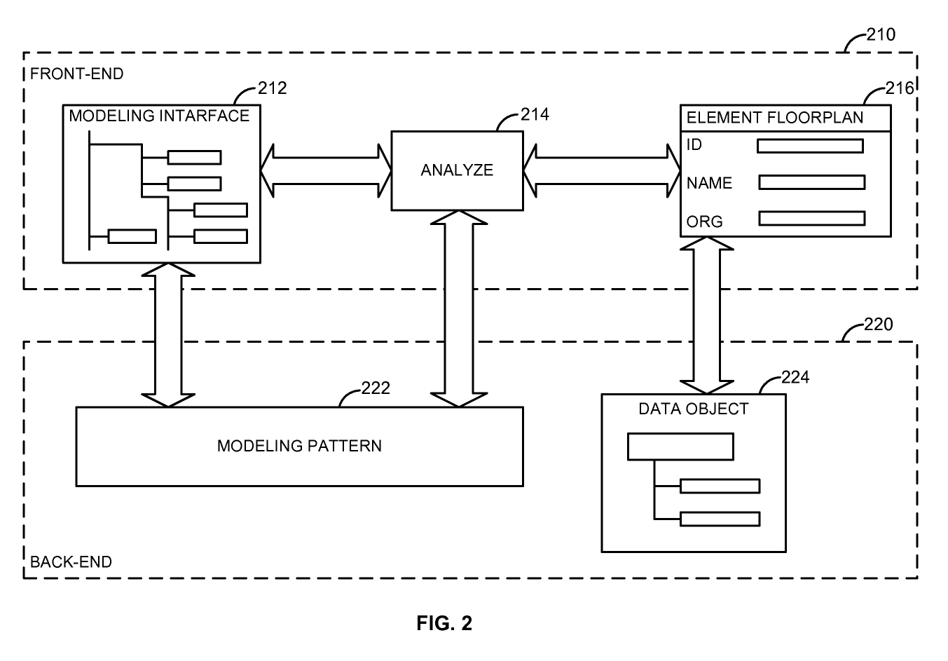

FIG. 2 is a functional block diagram of a system for implementing a data object assembly at runtime according to an embodiment of the invention. Modeling pattern 222 is typically included in backend 220. Modeling interface 212 included in frontend 210 generally makes one or more element requests to modeling pattern 222 using one or more interface elements in modeling interface 212. The element requests typically include activity requests such as create, display, query, link and the like. Modeling pattern 222 generally delegates the element requests to frontend 210. In an embodiment modeling pattern 222 stores the element type and a key of the element linked to a node in modeling pattern 222. On receiving the element request from modeling interface 212, modeling pattern 222 delegates the element request to frontend 210 along with the element type and the key of the element. Frontend 210 analyzes 214 the element request and maps the element type to a corresponding element provider. The element request is then further delegated to the element provider for execution. For example, the user may be presented with modeling interface 212 for an engineering change case. The user may click on an element in modeling interface 212 and select to display the element. The request for displaying the element may then be analyzed 214 and mapped to an element provider. The request may then be executed by the element provider and an element floorplan 216 for the element may be displayed to the user. Element floorplan 216 may receive data from data object 224 stored in backend 220. Other element requests may include a request to view a document upon selection in modeling interface 212, a request to add a node in modeling pattern 222, a request to create a new element, a request to link an element to a node in modeling pattern 222 and the like.

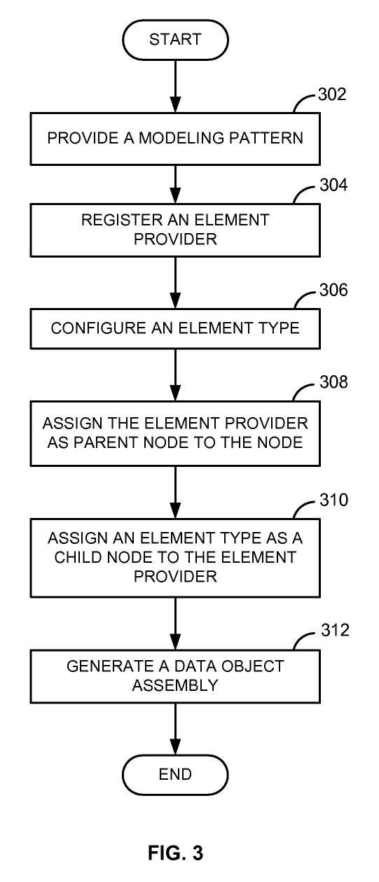

FIG. 3 is a flow diagram of a process for generating a data object assembly according to an embodiment of the invention. In process block 302, a modeling pattern is provided having a node arranged in a hierarchy of nodes. In process block 304, an element provider is registered for use in the modeling pattern. A node in the modeling pattern usually has one or more element providers modeled as the node. The element providers are typically technical providers behind the node including services like data object links handling, node handling, document handling and activity request handling. Thus, the element provider fixes the backend behavior of the node by fixing a specific data structure, the actions and the queries needed to work with the node. The registration of the element provider typically includes a node assignment and an element provider definition. In process block 306, an element type is configured for the element provider. The element type is typically a data object that a user may work with. A configuration of the element type typically includes an element type definition having definitions of one or more element types for each registered element provider. The configuration may also include a short text for the element type visible to the user. In process block 308, the element provider is assigned to the node as a parent node. In process block 310, an element type is assigned as a child node to the element provider. In process block 312, a data object assembly is generated using the modeling pattern.

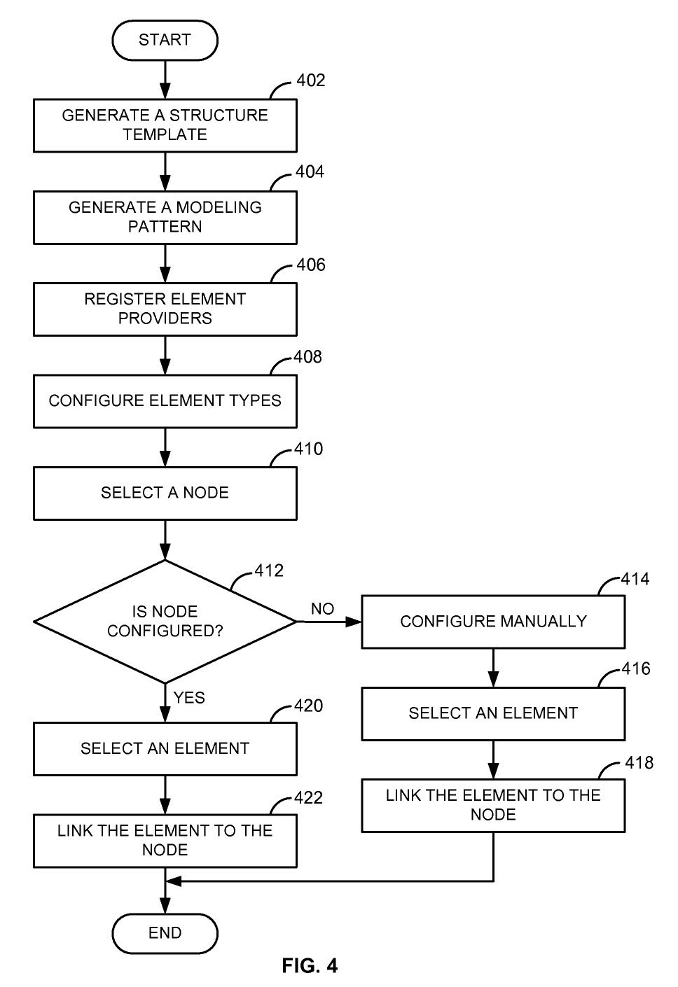

FIG. 4 is a flow diagram of a process for generating a data object assembly according to an embodiment of the invention. In process block 402, a structure template is generated. In process block 404, a modeling pattern is generated using the structure template. The modeling pattern typically includes a number of nodes arranged in a hierarchical order. The structure template typically defines a hierarchy of the nodes in the modeling pattern. In process block 406, one or more element providers are registered. A node in the modeling pattern usually has one or more element providers modeled as the node. The element providers are typically technical providers behind the node including services like data object link handling, node handling, document handling and activity request handling. Thus, the element provider fixes the backend behavior of the node by fixing a specific data structure. Registering the element provider typically includes registering a node assignment and an element provider definition in a registry table of a framework. Registering the element provider may also include declaring one or more customizing attributes for one or more element types. In process block 408, one or more element types are configured for each element provider. A configuration of an element type typically includes an element type definition, a language dependent short text and a value for valuating the customizing attribute registered by the element providers.

In process block 410, a node of the modeling pattern is selected by a user typically in a modeling interface. The modeling interface typically includes an interface element mapped to each of the nodes in the modeling pattern. The user typically selects the element provider using the interface element mapped to the node for the element provider in the modeling pattern. The interface element may include a button, a hyperlink, a selection box, a check box with a text, a menu option and the like. In decision block 412, if the node selected by the user is a node not configured in the framework, the process proceeds to process block 414 where the node is configured manually. Configuring the node manually may include, assigning an element provider to the node, defining the element provider, declaring one or more customizing attributes for the element types and defining one or more element types for the element provider. In process block 416, an element is selected for linking with the node. The element may either be created or selected from a list of available elements. In process block 418, the element is linked to the node. In decision block 412, if the node selected by the user is a node that is configured in the framework, the process moves to process block 420 where an element is selected for linking with the node. In process block 422, the element is linked to the node.

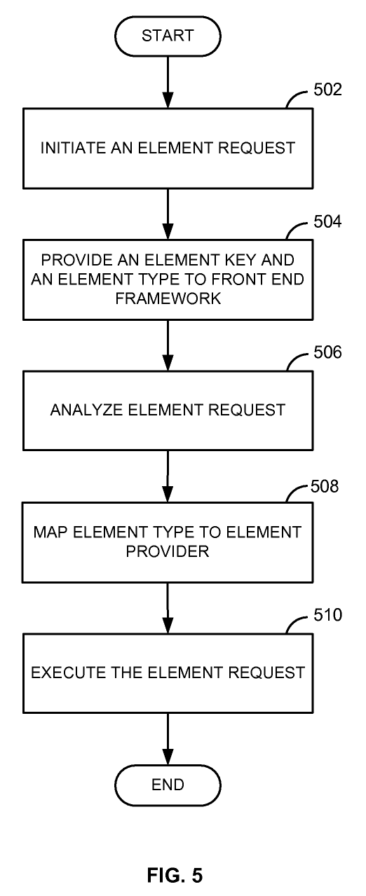

FIG. 5 is a flow diagram of a process for implementing a data object assembly at runtime according to an embodiment of the invention. In process block 502, an element request is initiated typically from a modeling interface on a node in a modeling pattern. A modeling interface is a user interface that typically enables a user to make element requests to the modeling pattern. The modeling interface typically includes an interface element mapped to each of the nodes in the modeling pattern. The user typically selects the element provider using the interface element mapped to the node for the element provider in the modeling pattern. The interface element may include a button, a hyperlink, a selection box, a check box with a text, a menu option and the like. The element request may include activity requests such as create, display, query, link and the like. In process block 504, an element key and an element type of the node is provided to a frontend framework. In process block 506, the element request is analyzed by the frontend framework. In process block 508, the element type is mapped to a corresponding element provider by the frontend framework. In process block 510, the element request is executed by the element provider.

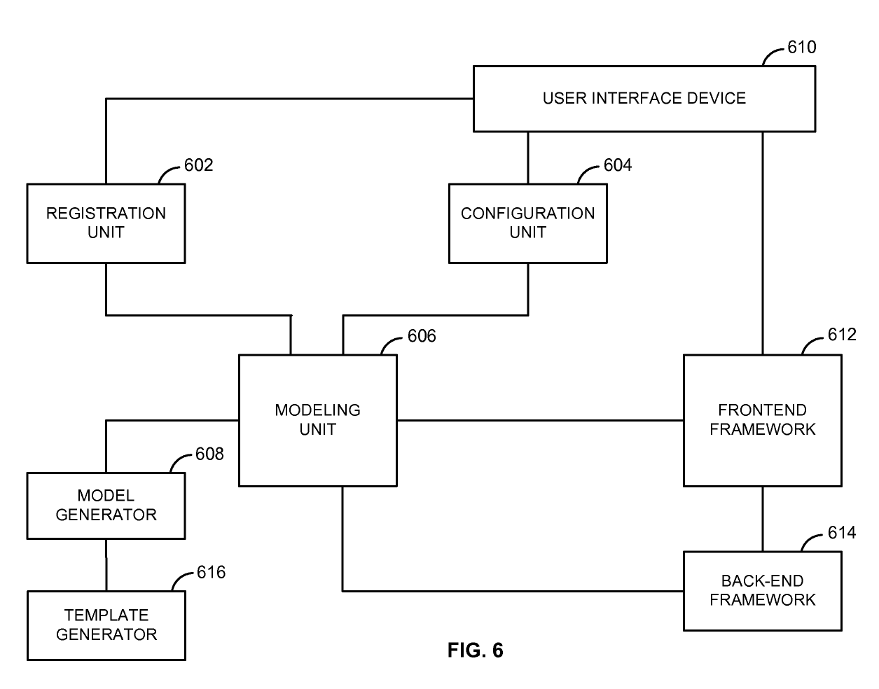

FIG. 6 is a block diagram of a system for generating a data object assembly useful for implementing the invention according to an embodiment of the invention. Model generator 608 generates a modeling pattern. The modeling pattern typically includes a number of nodes arranged in a hierarchical order. A node in the modeling pattern usually has one or more element providers modeled as the node. It is the responsibility of modeling unit 606 to model the element providers as nodes in the modeling pattern. The element providers are typically technical providers behind the node including services like data object links handling, node handling, document handling and activity request handling. The activity request handling generally includes requests for create, modify, display and the like. Thus, the element provider fixes the backend behavior of the node by fixing a specific data structure, the actions and the queries needed to work with the node. An element provider node may typically have one or more element types associated with the element provider. Element providers are usually invisible and the user generally works with the element types. The modeling pattern is typically stored in backend framework 614. Template generator 616 typically generates a structure template that defines a hierarchical order of the nodes in the modeling pattern.

Registration unit 602 typically registers element providers in a framework registry table stored in backend framework 614. A registration of an element provider typically includes registering a node assignment and an element provider definition by registration unit 602. The node assignment generally includes assigning an element provider to a node in the modeling pattern. The node assignment is typically done by registration unit 602 by assigning node identifiers of the nodes in the modeling pattern to the respective element providers. The element provider definition typically includes one or more customizing attributes specific to each element type.

When an element provider is modeled in the modeling pattern by modeling unit 606 and registered by registration unit 602, at least one element type corresponding to the element provider must be configured in a configuration table typically stored in backend framework 614 for the user to be able to work with the element provider. Configuration of the element types is typically done by configuration unit 604. Configuration typically includes element type definitions having definitions of one or more element types for each registered element provider. Each element type definition includes a language dependent short text that is typically visible to the user as the name of the element type while working with the modeling pattern in a user interface. The element type definition further defines values for valuating customizing attributes declared by the element provider during registration. It is the responsibility of modeling unit 606 to model the element providers and element types as nodes in the modeling pattern based upon a registration data and a configuration data received either directly from registration unit 602 and configuration unit 604 or from backend framework 614. In an embodiment, modeling unit 606 assigns an element provider as a parent node in the modeling pattern and one or more element types as child nodes to the element provider in the modeling pattern.

User interface device 610 is typically used by a user to register element providers using registration unit 602, configure element types using configuration unit 604 and model the modeling pattern to generate a data object assembly using modeling unit 606.

The modeling pattern is typically presented to the user as a modeling interface in user interface device 610. The modeling interface is a user interface that typically enables a user to make element requests to the modeling pattern in backend framework 614. The modeling interface typically includes an interface element mapped to each of the nodes in the modeling pattern. The user typically selects an element provider using the interface element mapped to the node for the element provider in the modeling pattern. The interface element may include a button, a hyperlink, a selection box, a check box with a text, a menu option and the like. The element request may include activity requests such as create, display, query, link and the like. An element key and an element type of the node is provided by backend framework 614 to frontend framework 612. The element request is analyzed by frontend framework 612. The element type is mapped to a corresponding element provider in backend framework 614 by frontend framework 612. The element request is executed by backend framework 614 using the element provider.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
providing a modeling pattern having a node arranged in a hierarchy of nodes;
registering an element provider for use in the modeling pattern;
configuring an element type for the element provider;
assigning the element provider as a parent node to the node;
assigning the element type as a child node to the element provider; and
generating a data object assembly using the modeling pattern.

2. The method of claim 1, wherein registering an element provider comprises:
assigning a node number of the node to the element provider; and
declaring a customizing attribute for the element provider.

3. The method of claim 1, wherein configuring an element type comprises:
declaring a text for the element type; and
valuating a customizing attribute declared by the element provider for the element type.

4. The method of claim 1 further comprising generating a structure template to determine the position of the node in the hierarchy of nodes.

5. The method of claim 1 further comprising generating a link to an element of the element type.

6. The method of claim 1 further comprising attaching a document to the node.

7. The method of claim 1 further comprising generating a link between a first element of the element type and a second element of a second element type, the second element being assigned to a second element provider.

8. The method of claim 1 further comprising storing an element key for an element of the element type in the modeling pattern.

9. The method of claim 1 further comprising:
receiving an activity request for an element of the element type;
providing an element key of the element and the element type to a framework;
analyze the activity request in the framework;
map the element type to the element provider; and
executing the activity request using the element provider.

10. A system comprising:
a model generator for providing a modeling pattern having a node arranged in a hierarchy of nodes;
a registration unit for registering an element provider for use in the modeling pattern;
a configuration unit for configuring an element type for the element provider; and
a modeling unit electronically coupled to the model generator, the registration unit and the configuration unit for assigning the element provider as a parent node to the node, assigning an element type as a child node to the element provider and generating a data object assembly using the modeling pattern.

11. The system of claim 10 further comprising a template generator electronically coupled to the model generator for determining the position of the node in the hierarchy of nodes.

12. The system of claim 10 further comprising a backend framework electronically coupled to the modeling unit for storing a registration data registered by the registration unit, a configuration data configured by the configuring unit, the modeling pattern provided by the model generator and the data object assembly.

13. The system claim 10 further comprising a frontend framework electronically coupled to the modeling unit, a backend framework and a user interface device for receiving an element key of an element and the element type from the backend framework in response to an element request, analyzing the element request and mapping the element type to the element provider.

14. A machine-accessible medium that provides instructions that, when executed by a machine, cause the machine to perform operations comprising:
providing a modeling pattern having a node arranged in a hierarchy of nodes;
registering an element provider for use in the modeling pattern;
configuring an element type for the element provider;
assigning the element provider as a parent node to the node;
assigning the element type as a child node to the element provider; and
generating a data object assembly using the modeling pattern.

15. The machine-accessible medium of claim 14, wherein registering an element provider comprises:
assigning a node number of the node to the element provider; and
declaring a customizing attribute for the element provider.

16. The machine-accessible medium of claim 14, wherein configuring an element type comprises:
declaring a text for the element type; and
valuating a customizing attribute declared by the element provider for the element type.

17. The machine-accessible medium of claim 14 further providing instructions which when executed by the machine cause the machine to perform further operations comprising generating a structure template to determine the position of the node in the hierarchy of nodes.

18. The machine-accessible medium of claim 14 further providing instructions which when executed by the machine cause the machine to perform further operations comprising generating a link to an element of the element type.

19. The machine-accessible medium of claim 14 further providing instructions which when executed by the machine cause the machine to perform further operations comprising attaching a document to the node.

20. The machine-accessible medium of claim 14 further providing instructions which when executed by the machine cause the machine to perform further operations comprising:
receiving an activity request for an element of the element type;
providing an element key of the element and the element type to a framework;
analyze the activity request in the framework;
map the element type to the element provider; and
executing the activity request using the element provider.
